(19) United States
(12) Patent Application Publication
(10) Pub. No.: US 2026/0323601 A1
(43) Pub. Date: Oct. 15, 2026

(54) METHOD AND APPARATUS FOR DETERMINING AMOUNT OF TRANSMITTED INFORMATION, AND DEVICE AND STORAGE MEDIUM

(71) Applicant: ZTE CORPORATION, Shenzhen, Guangdong (CN)

(72) Inventors: Weimin XING, Shenzhen (CN); Haigang HE, Shenzhen (CN); Youxiong LU, Shenzhen (CN); Yuzhou HU, Shenzhen (CN); Jie CHEN, Shenzhen (CN); Ting MIAO, Shenzhen (CN)

(21) Appl. No.: 19/472,178

(22) PCT Filed: Mar. 27, 2024
(86) PCT No.: PCT/CN2024/083944

§ 371 Date: Oct. 3, 2025

(30) Foreign Application Priority Data
Apr. 4, 2023 (CN) 202310374290.5

(51) Int. Cl. H04W 72/044; H04W 28/26; H04W 72/25

(52) U.S. Cl. CPC H04W 72/044; H04W 28/26; H04W 72/25

(57) ABSTRACT

Provided are a method for determining the amount of transmitted information, an apparatus for determining the amount of transmitted information, a device, and a storage medium. The method includes acquiring channel resource configuration information and/or channel resource indication information; determining the number of target symbols based on the channel resource configuration information and/or the channel resource indication information; and determining the amount of transmitted information based on the number of target symbols to transmit an information block based on the amount of transmitted information. In the method for determining the amount of transmitted information provided by the embodiments of the present application, the amount of transmitted information for each transmission of an information block is determined based on the determined number of target symbols, ensuring that the amount of transmitted information is the same in each transmission, thereby improving the success rate of data transmission.

### TECHNICAL FIELD

Embodiments of the present application relate to the field of communication technology, and in particular, to a method for determining an amount of transmitted information, an apparatus for determining an amount of transmitted information, a device, and a storage medium.

### BACKGROUND

According to current data transmission technology, a transmitting device may need to repeatedly transmit the same data multiple times to ensure correct reception by a receiving device. Here, a piece of data is referred to as an information block or transport block (TB), which is typically carried on a data channel. For example, in the case of direct communication, the TB is typically carried on the physical sidelink shared channel (PSSCH). The receiving device may combine multiple transmissions of the same TB and decoding the combined transmissions to improve the success probability of reception. This combining requires that each of the multiple transmissions carries same information, and the amounts of transmitted information, that is, the TB sizes, are the same. In the related art, the resources used for each transmission of the same TB in multiple transmissions are generally identical or have minimal differences, so devices typically determine the TB size based on the resource size used in the first transmission. However, for direct communication, particularly in unlicensed bands, it is challenging to ensure that the resource size for multiple transmissions of a TB remains constant. For example, the number of symbols available for each transmission may vary, requiring the device to comprehensively consider the potential resource sizes for multiple transmissions to determine an appropriate TB size.

### SUMMARY

Embodiments of the present application provide a method for determining the amount of transmitted information, an apparatus for determining the amount of transmitted information, a device, and a storage medium. The amount of transmitted information for each transmission of an information block is determined based on the determined number of target symbols, ensuring that the amount of transmitted information is the same in each transmission, thereby improving the success rate of data transmission.

To achieve the preceding object, embodiments of the present application disclose a method for determining the amount of transmitted information. The method includes the following:

At least one of channel resource configuration information or channel resource indication information is acquired.

The number of target symbols is determined based on at least one of the channel resource configuration information or the channel resource indication information.

The amount of transmitted information is determined based on the number of target symbols to transmit an information block based on the amount of transmitted information.

To achieve the preceding object, embodiments of the present application disclose an apparatus for determining the amount of transmitted information. The apparatus includes a channel resource information acquisition module, a target symbol quantity determination module, and a transmission information amount determination module.

The channel resource information acquisition module is configured to acquire at least one of channel resource configuration information or channel resource indication information.

The target symbol quantity determination module is configured to determine the number of target symbols based on at least one of the channel resource configuration information or the channel resource indication information.

The transmission information amount determination module is configured to determine the amount of transmitted information based on the number of target symbols to transmit an information block based on the amount of transmitted information.

To achieve the preceding object, embodiments of the present application disclose a computer device. The device includes a memory, a processor, and a computer program stored on the memory and executable on the processor. The processor, when executing the program, implements the method for determining the amount of transmitted information as described in the embodiments of the present application.

To achieve the preceding object, embodiments of the present application disclose a computer-readable storage medium storing a computer program. The program, when executed by a processor, implements the method for determining the amount of transmitted information as described in the embodiments of the present application.

Embodiments of the present application provide a method for determining the amount of transmitted information, an apparatus for determining the amount of transmitted information, a device, and a storage medium. The method includes acquiring channel resource configuration information and/or channel resource indication information; determining the number of target symbols based on the channel resource configuration information and/or the channel resource indication information; and determining the amount of transmitted information based on the number of target symbols to transmit an information block based on the amount of transmitted information. In the method for determining the amount of transmitted information provided by the embodiments of the present application, the amount of transmitted information for each transmission of an information block is determined based on the determined number of target symbols, ensuring that the amount of transmitted information is the same in each transmission, thereby improving the success rate of data transmission.

### BRIEF DESCRIPTION OF DRAWINGS

FIG. 1 is a flowchart of a method for determining the amount of transmitted information according to an embodiment of the present application.

FIG. 2 is a diagram illustrating the structure of an apparatus for determining the amount of transmitted information according to an embodiment of the present application.

FIG. 3 is a diagram illustrating the structure of a computer device according to an embodiment of the present application.

### DETAILED DESCRIPTION

To illustrate the object, solutions, and advantages of the present application more clearly, embodiments of the present application are described hereinafter in detail in conjunction with drawings. It is to be noted that if not in collision, embodiments of the present application and features therein may be combined with each other in any manner.

It is to be understood that the specific embodiments described herein are intended to explain the present application and not to limit the present application.

Suffixes such as “module”, “component”, or “unit” used for indicating elements in the subsequent description are used only for facilitating the description of the present application and have no particular meaning in themselves. Therefore, “module”, “component”, or “unit” may be used in a mixed manner.

Direct communication, also referred to as sidelink (SL) communication, edge communication, bypass communication, or short-range communication, is hereinafter referred to as SL communication for all direct communication. Sidelink communication still uses the same synchronized frame structure as cellular networks. In the related art, a radio frame is 10 ms, including 10 subframes of 1 ms each, and depending on the numerology, a subframe includes several slots. Numerology may be understood as a set of parameters, mainly referring to the sub-carrier spacing (SCS), cyclic prefix (CP) length, and other parameters. Different subcarrier spacings result in different symbol time lengths. When user equipment (UE) performs SL communication, it typically operates within an SL communication resource pool. An SL resource pool may include several slots in the time domain.

SL communication currently operates in licensed or dedicated frequency bands. For example, vehicle-to-everything (V2X) communication may operate in a frequency band dedicated to vehicle networking. In recent years, with the development of SL communication, the demand for SL transmission in traditional unlicensed bands has become increasingly strong. Before performing SL transmission in unlicensed bands, UE must follow the relevant band usage regulations and perform a channel access process, generally referred to as the listen-before-talk (LBT) process. If the channel resource is determined to be idle (LBT successful) within the detection duration corresponding to the LBT process, the UE may proceed with transmission. After the LBT process, if the LBT is successful, the UE may not only perform transmission but also perform an initiation of a channel occupancy time (COT) or channel occupancy (CO). One channel occupancy typically lasts longer than one slot.

Currently, SL communication generally occupies resources in units of slots, but this does not mean that all symbols within a slot can be used for effective information transmission. The number of symbols available for information transmission, that is, the number of symbols used to calculate the TB size, is reduced due to the following factors:
Factor 1 (semi-static factor): In some slots, other channel resources (also referred to as signal resources) are configured, including but not limited to at least one of the following: resources configured for reference signals, such as positioning reference signals and reference signals for channel estimation or beam training; resources configured for special channels, which may be signals for feedback or channels for control, such as physical sidelink feedback channel (PSFCH) resources or physical sidelink control channel (PSCCH) resources.
Factor 2 (dynamic factor): During channel access in unlicensed bands, the starting symbol used in a slot may include at least one of the following situations: when the UE initiates a COT in a slot using LBT, if the LBT fails for the first available symbol in the slot (that is, the channel is determined to be occupied), the UE may continue LBT detection. If LBT succeeds on a subsequent symbol in the current slot, the UE may perform channel access on the symbol. For example, if LBT fails on symbol 0 but succeeds on symbol 4, the UE may start transmission from symbol 4 until the slot ends. Within an already initiated COT, such as in a scenario similar to initiating a COT as described above, the UE may have multiple starting symbols, or may support only one starting symbol. In any case, this may result in different numbers of starting symbols across different slots.
Factor 3 (static factor): Each slot reserves some symbols for special purposes, such as for automatic gain control (AGC) or guard period (GP), and this factor is present by default in every slot.

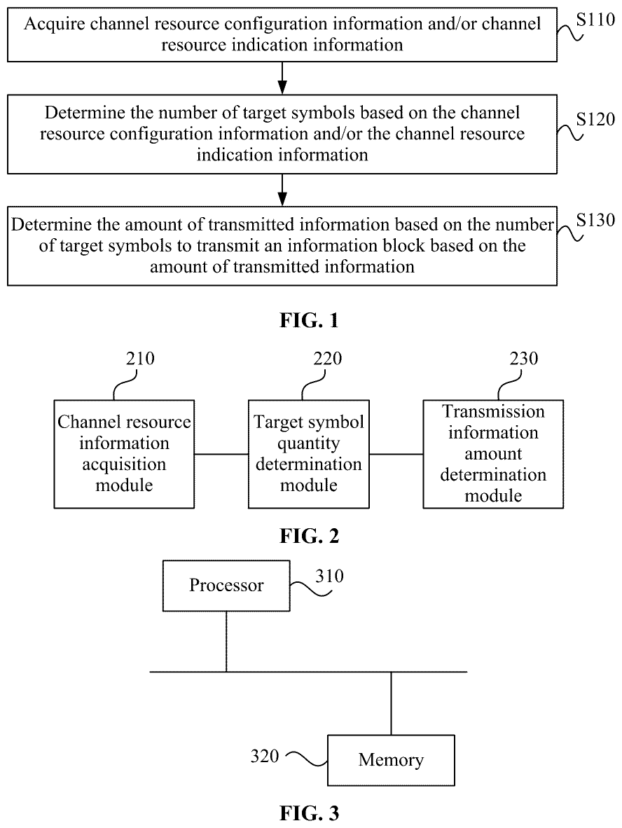

In an embodiment, FIG. 1 is a flowchart of a method for determining the amount of transmitted information according to an embodiment of the present application. This method is applicable to determining the amount of transmitted information for an information block and may be executed by an apparatus for determining the amount of transmitted information. The apparatus may be a communication device. As shown in FIG. 1, the method includes S110 to S130.

In S110, channel resource configuration information and/or channel resource indication information is acquired.

The channel resource configuration information may be acquired from a base station, a user equipment or server specifically used for configuring channel resources, preconfigured information input at the time of the user equipment's manufacture, predefined information from a protocol, or provided by the higher layer of the current user equipment to the lower layer. The source of the channel resource configuration information is not limited herein. The channel resource indication information may be carried in control information corresponding to the channel resources used for transmitting the information block, such as sidelink control information (SCI), to indicate information about the channel resources. The channel resource indication information may be input by the user of the current user equipment or provided by the higher layer of the current user equipment to the lower layer.

The channel resource indication information includes indicating that other channel resources are not used or indicating that other channel resources are used. Indicating that other channel resources are not used may be understood as not considering the impact of other channel resources on the number of symbols when the number of target symbols is determined. Indicating that other channel resources are used may be understood as considering the impact of other channel resources on the number of symbols when the number of target symbols is determined.

The channel resource configuration information includes at least one of the following: other channel resources being configured, other channel resources not being configured, the total symbol length, the number of starting symbols, the at least one starting symbol position, the number of reserved symbols, the number of first symbols corresponding to other channel resources, or an occupancy period of other channel resources.

In this embodiment, the other channel resources may include feedback channel resources and/or control channel resources. Other channel resources being configured may be understood as channel resources of another channel consuming part of the number of symbols, while other channel resources not being configured may be understood as no channel resources of another channel consuming symbols in the slot. The total symbol length N1 may be understood as the number of symbols available for SL communication in a slot. The number of starting symbols may be understood as the number of symbols in a slot available for channel access, which may be a positive integer greater than or equal to 1, such as 2. The at least one starting symbol position may be understood as the at least one position of at least one symbol in a slot available for channel access, and for example, a configured UE may perform channel access at a position of symbol 0 and a position of symbol 4, and in this case, the number of starting symbols is 2. The number of reserved symbols X3 may be understood as the number of symbols reserved in a slot for purposes such as AGC and GP, that is, the number of symbols corresponding to Factor 3 in the preceding embodiment. For example, the number of reserved symbols may be set to 2. The number of first symbols X1 corresponding to other channel resources may be understood as the number of symbols consumed by other channel resources, that is, the number of symbols corresponding to Factor 1 in the preceding embodiment. For example, the number of first symbols may be set to 3. The occupancy period of other channel resources may be understood as the slot period for configuring other channel resources. Assuming the occupancy period is T, it can be understood that other channel resources are configured every T slots. For example, if the occupancy period is 1, every slot is configured with channel resources of another channel; if the occupancy period is 4, other channel resources are configured every 4 slots. The slot period here may correspond to physical slots numbered in physical time order or logical slots numbered in the slot order of the resource pool.

In S120, the number of target symbols is determined based on the channel resource configuration information and/or the channel resource indication information.

The number of target symbols may be understood as the number of symbols used to determine the amount of transmitted information for the TB, ensuring that the TB is transmitted with the same amount of transmitted information in each retransmission.

In an embodiment, in response to the number of starting symbols being one, it indicates that Factor 2 does not exist in the resource pool for transmitting a PSSCH by the UE, or Factor 2 exists but is not considered. In other words, the resource pool is configured not to allow multiple starting symbols, or no additional starting symbols are configured. In this case, determining the number of target symbols based on the channel resource configuration information and/or the channel resource indication information includes the following scenarios: In the case where other channel resources are configured or the occupancy period of other channel resources is 1, the number of target symbols is determined based on the total symbol length, the number of reserved symbols, and the number of first symbols. In the case where other channel resources are configured or the occupancy period of other channel resources is greater than 1, the number of target symbols is determined based on the total symbol length, the number of reserved symbols, and the number of second symbols determined according to the channel resource indication information. In the case where other channel resources are not configured or the occupancy period of other channel resources is 0, the number of target symbols is determined based on the total symbol length and the number of reserved symbols.

Other channel resources are configured or the occupancy period of other channel resources is 1, which may be understood as that every slot is configured with channel resources of another channel. Determining the number of target symbols based on the total symbol length, the number of reserved symbols, and the number of first symbols may be as follows: The number of target symbols is acquired by subtracting the number of reserved symbols and the number of first symbols from the total symbol length. The formula may be expressed as follows: N=N1−X1−X3.

Other channel resources are configured or the occupancy period of other channel resources is greater than 1, which may be understood as that some slots are configured with channel resources of another channel. If the channel resource indication information indicates that other channel resources are not used, the determined number of second symbols is 0, that is, X2=0; if the channel resource indication information indicates that other channel resources are used, the determined number of second symbols is equal to the number of first symbols, that is, X2=X1. Determining the number of target symbols based on the total symbol length, the number of reserved symbols, and the number of second symbols determined according to the channel resource indication information may be as follows: The number of target symbols is acquired by subtracting the number of reserved symbols and the number of second symbols determined according to the channel resource indication information from the total symbol length. The formula may be expressed as follows: N=N1−X2−X3.

In the case where other channel resources are not configured or the occupancy period of other channel resources is 0, it can be understood that Factor 1 does not exist in the resource pool. Then, determining the number of target symbols based on the total symbol length and the number of reserved symbols may be as follows: The number of target symbols is acquired by subtracting the number of reserved symbols from the total symbol length. The formula may be expressed as follows: N=N1−X3.

In an example, an occupancy period of 0 for other channel resources may also be understood as X2 being implicitly indicated as 0. In other words, X2 may be determined as 0 without channel resource indication information. Similarly, an occupancy period of 1 for other channel resources may be understood as X2 being implicitly indicated as equal to X1.

In an embodiment, in the case where the number of starting symbols is greater than 1, it indicates that Factor 2 exists in the resource pool for transmitting a PSSCH by the UE, that is, the resource pool is configured to allow multiple starting symbols or additional starting symbols are configured. Since Factor 2 is a dynamic factor and unpredictable, the channel resource configuration information also includes at least one reference symbol length. The reference symbol length is less than or equal to the total symbol length. In this case, determining the number of target symbols based on the channel resource configuration information and/or the channel resource indication information may be as follows: In the case where other channel resources are not configured or the occupancy period of other channel resources is 0, the number of target symbols is determined based on the at least one reference symbol length and the number of reserved symbols. In the case where other channel resources are configured or the occupancy period of other channel resources is 1, the number of target symbols is determined based on the total symbol length, the number of reserved symbols, and the number of first symbols.

In the case where other channel resources are not configured or the occupancy period of other channel resources is 0, it can be understood that Factor 1 does not exist in the resource pool, but Factors 2 and 3 exist. With an example where one reference symbol length N2 is configured, determining the number of target symbols based on at least one reference symbol length and the number of reserved symbols may be as follows: the number of target symbols is acquired by subtracting the number of reserved symbols from the at least one reference symbol length. The formula may be expressed as follows: N=N2−X3.

Other channel resources are configured or the occupancy period of other channel resources is 1, which may be understood as that every slot is configured with channel resources of another channel. That is, Factor 1 exists in each slot. Then, determining the number of target symbols based on the total symbol length, the number of reserved symbols, and the number of first symbols may be as follows: the number of target symbols is acquired by subtracting the number of reserved symbols and the number of first symbols from the total symbol length. The formula may be expressed as follows: N=N1−X2−X3.

In an embodiment, in the case where the number of starting symbols is greater than 1, the channel resource configuration information also includes at least one reference symbol length. Determining the number of target symbols based on the channel resource configuration information and/or the channel resource indication information may be as follows: In the case where other channel resources are configured or the occupancy period of other channel resources is greater than 1, the number of first candidate symbols is determined based on the total symbol length, the number of reserved symbols, and the number of second symbols determined according to the channel resource indication information; the number of second candidate symbols is determined based on the at least one reference symbol length and the number of reserved symbols; and the number of target symbols is determined from the number of first candidate symbols and the number of second candidate symbols.

Other channel resources are configured or the occupancy period of other channel resources is greater than 1, which may be understood as that some slots are configured with channel resources of another channel. Determining the number of first candidate symbols based on the total symbol length, the number of reserved symbols, and the number of second symbols determined according to the channel resource indication information may be as follows: The number of first candidate symbols is acquired by subtracting the number of reserved symbols and the number of second symbols determined according to the channel resource indication information from the total symbol length. The formula may be expressed as follows: D1=N1−X2−X3. Determining the number of second candidate symbols based on the at least one reference symbol length and the number of reserved symbols may be as follows: The number of second candidate symbols is acquired by subtracting the number of reserved symbols from the at least one reference symbol length. The formula may be expressed as follows: D2=N2−X3. Determining the number of target symbols from the number of first candidate symbols and the number of second candidate symbols may be as follows: The maximum, minimum, or average value of the number of first candidate symbols and the number of second candidate symbols is used as the number of target symbols.

In an example, in the case where the number of starting symbols is greater than 1, the channel resource configuration information also includes at least one reference symbol length. Determining the number of target symbols based on the channel resource configuration information and/or the channel resource indication information may be as follows: Other channel resources are configured or the occupancy period of other channel resources is greater than 1, which may be understood as that some slots are configured with channel resources of another channel. The number of target symbols is determined based on the at least one reference symbol length, the number of reserved symbols, and the number of second symbols determined according to the channel resource indication information. The formula may be expressed as follows: N=N2−X2−X3.

In an example, in the case where the number of starting symbols is greater than 1, the channel resource configuration information also includes at least one reference symbol length, or no reference symbol length is configured. Determining the number of target symbols based on the channel resource configuration information and/or the channel resource indication information may be as follows: in the case where one reference symbol length N2 is configured, it may be understood as using the one reference symbol length to determine the number of target symbols. The method may be as follows: when Factor 1 is not considered, the number of reserved symbols is subtracted from the one reference symbol length, expressed as that N=N2−X3. Alternatively, when Factor 1 is considered, the number of reserved symbols and the number of second symbols are subtracted from the one reference symbol length, expressed as that N=N2−X2−X3. Alternatively, N is the minimum value of N1−X2−X3 and N2−X3. In the case where no reference symbol length is configured, it may be understood as using the total symbol length to determine the number of target symbols. The method may be as follows: when Factor 1 is not considered, the number of reserved symbols is subtracted from the total symbol length, expressed as that N=N1−X3. Alternatively, when Factor 1 is considered, the number of reserved symbols and the number of second symbols are subtracted from the total symbol length, expressed as that N=N1−X2−X3.

In an embodiment, the at least one reference symbol length is configured in any one of the following manners: in the case where the channel resource configuration information is configured with at least one symbol offset value, the at least one reference symbol length is determined based on the at least one symbol offset value and the total symbol length. In the case where the channel resource configuration information is configured with at least one symbol length value, the at least one reference symbol length is determined based on the at least one symbol length value.

The symbol offset value may be understood as the offset between the at least one reference symbol length N2 and the total symbol length N1. If the symbol offset value is X_{delta}, the at least one reference symbol length may be calculated as follows: N2=N1−X_{delta}. The symbol length value may be understood as the specific value corresponding to the at least one reference symbol length.

In an embodiment, in the case where the channel resource configuration information includes the at least one reference symbol length, the channel resource indication information also includes indicating that the at least one reference symbol length or the total symbol length is used; or, the transmission is a transmission for initiation of a channel occupancy time or a transmission within a channel occupancy time.

Using the at least one reference symbol length may be understood as determining the number of target symbols using the at least one reference symbol length. Using the total symbol length may be understood as determining the number of target symbols using the total symbol length. If it is indicated to use the at least one reference symbol length to determine the number of target symbols, the method may be as follows: The number of reserved symbols is subtracted from the at least one reference symbol length, expressed as that N=N2−X3. If it is indicated to use the total symbol length to determine the number of target symbols, the method may be as follows: The number of reserved symbols and the number of second symbols are subtracted from the total symbol length, expressed as that N=N1−X3−X2. The value of X2 depends on the configuration of other channel resources. In the case where other channel resources are configured or the occupancy period of other channel resources is 1, X2 takes a value greater than 0 (such as 3). In the case where other channel resources are not configured or the occupancy period of other channel resources is 0, X2 takes a value of 0.

The transmission within a COT may be understood as transmission within a shared COT. For example, multiple transmissions of a TB by a UE are within a COT initiated by another UE or by itself. In an example, transmissions within an already initiated COT are highly likely to access the channel at the first starting symbol, and subsequent starting symbols are generally not used, so the impact of Factor 2 on the number of PSSCH symbols may not be considered. For example, if the SCI indicates that the transmission corresponds to initiating a COT, it is equivalent to indicating that Factor 2 is considered, and the process of determining the number of symbols N by the UE is as described in the preceding example. Conversely, if the transmission is indicated as a transmission within a COT, it is equivalent to indicating that Factor 2 is not considered.

In an embodiment, the channel resource indication information may also be used to indicate the mode for calculating the number of target symbols. For example, in the first mode, the at least one reference symbol length is used for calculation, and in the second mode, the total symbol length is used for calculation.

In an embodiment, determining the number of target symbols based on the channel resource configuration information and/or the channel resource indication information may be as follows: in the case where the at least one reference symbol length includes one reference symbol length and the resource indication information indicates that the at least one reference symbol length is used or that the transmission is the transmission for the initiation of the channel occupancy time, the number of target symbols is determined based on the at least one reference symbol length and the number of reserved symbols. In the case where the resource indication information indicates using the total symbol length or that the transmission is a transmission within a channel occupancy time, the number of target symbols is determined based on the total symbol length, the number of reserved symbols, and the number of first symbols, or the number of target symbols is determined based on the total symbol length, the number of reserved symbols, and the number of second symbols determined according to the channel resource indication information.

Determining the number of target symbols based on the at least one reference symbol length and the number of reserved symbols may be as follows: the number of target symbols is acquired by subtracting the number of reserved symbols from the at least one reference symbol length. The formula is expressed as follows: N=N2−X3. Determining the number of target symbols based on the total symbol length, the number of reserved symbols, and the number of first symbols may be as follows: The number of target symbols is acquired by subtracting the number of reserved symbols and the number of first symbols from the total symbol length. The formula is expressed as follows: N=N1−X3−X1. Determining the number of target symbols based on the total symbol length, the number of reserved symbols, and the number of second symbols determined according to the channel resource indication information may be as follows: The number of target symbols is acquired by subtracting the number of reserved symbols and the number of second symbols determined according to the channel resource indication information from the total symbol length. The formula is expressed as follows: N=N1−X3−X2.

In another example, determining the number of target symbols using the at least one reference symbol length based on the channel resource configuration information and/or the channel resource indication information may be as follows: When Factor 1 is not considered, the number of reserved symbols is subtracted from the at least one reference symbol length, expressed as that N=N2−X3. Alternatively, when Factor 1 is considered, the number of reserved symbols and the number of second symbols are subtracted from the at least one reference symbol length, expressed as that N=N2−X2−X3. Alternatively, N is the minimum value of N1−X2−X3 and N2−X3. Determining the number of target symbols using the total symbol length may be as follows: When Factor 1 is not considered, the number of reserved symbols is subtracted from the total symbol length, expressed as that N=N1−X3. Alternatively, when Factor 1 is considered, the number of reserved symbols and the number of second symbols are subtracted from the total symbol length, expressed as that N=N1−X2−X3.

In an embodiment, in the case where the at least one reference symbol length includes multiple reference symbol lengths, the resource indication information also includes an indication field for determining the used reference symbol length. The indication field includes at least one of the following: an indication that the transmission is a transmission for initiation of a channel occupancy time, an indication that the transmission is a transmission within a channel occupancy time, an indication of a symbol length value, or a symbol length index value.

In this case, determining the number of target symbols based on the channel resource configuration information and/or the channel resource indication information may be as follows: The used reference symbol length is determined based on the indication field. The number of target symbols is determined based on the used reference symbol length.

In an embodiment, determining the used reference symbol length based on the indication field may be as follows: in the case where the indication field indicates that the transmission is a transmission for initiation of a channel occupancy time, the used reference symbol length is determined based on the reference symbol length corresponding to the initiation of the channel occupancy time. In the case where the indication field indicates that the transmission is a transmission within a channel occupancy time, the used reference symbol length is determined based on the reference symbol length corresponding to the transmission within the channel occupancy time. Alternatively, the used reference symbol length is determined based on the symbol length value or the symbol length index value indicated by the indication field.

Two reference symbol lengths are used as an example, denoted as N2 and N3. The reference symbol length corresponding to the initiation of a channel occupancy time may be set as N2, and the reference symbol length corresponding to the transmission within a channel occupancy time may be set as N3.

In an embodiment, in the case where the at least one reference symbol length includes multiple reference symbol lengths, the channel resource indication information may also be used to indicate the mode for calculating the number of target symbols. For example, in the first mode, the reference symbol length N2 is used for calculating the number of target symbols; in the second mode, the reference symbol length N3 is used for calculating the number of target symbols, and in the third mode, the total symbol length is used for calculating the number of target symbols.

In an embodiment, in the case where other channel resources are configured or the occupancy period of other channel resources is greater than 1, determining the number of target symbols based on the used reference symbol length may be as follows: the number of third candidate symbols is determined based on the total symbol length, the number of reserved symbols, and the number of second symbols determined according to the channel resource indication information; the number of fourth candidate symbols is determined based on the used reference symbol length and the number of reserved symbols; and the number of target symbols is determined from the number of third candidate symbols and the number of fourth candidate symbols.

Determining the number of third candidate symbols based on the total symbol length, the number of reserved symbols, and the number of second symbols determined according to the channel resource indication information may be as follows: the number of third candidate symbols is determined by subtracting the number of reserved symbols and the number of second symbols determined according to the channel resource indication information from the total symbol length, expressed as that D3=N1−X3−X2. Determining the number of fourth candidate symbols based on the used reference symbol length and the number of reserved symbols may be as follows: the number of fourth candidate symbols is determined by subtracting the number of reserved symbols from the used reference symbol length, expressed as that D4=Xi−X3, where Xi denotes the used reference symbol length. Determining the number of target symbols from the number of third candidate symbols and the number of fourth candidate symbols may be as follows: the maximum value, minimum value, or average value of the number of third candidate symbols and the number of fourth candidate symbols is used as the number of target symbols.

In S130, the amount of transmitted information is determined based on the number of target symbols to transmit an information block based on the amount of transmitted information.

In an embodiment, to determine the amount of transmitted information for a TB, the total number of resource elements (REs) corresponding to the PSSCH must first be determined. An RE is one subcarrier in the frequency domain and one symbol in the time domain. To determine the total number of REs, the number of REs within a physical resource block (PRB) must first be determined. The number of REs within a PRB based on the number of target symbols may be expressed as follows:

$${N}_{RE}^{′} = {N}_{SC}^{RB} \cdot N - {N}_{oh}^{PRB} - {N}_{RE}^{RS} .$$

In the formula, N′_{RE} denotes the number of REs within a PRB,

$${N}_{SC}^{RB}$$

denotes the number or subcarriers included in a PRB,

$${N}_{oh}^{PRB}$$

denotes the configured fixed overhead (not involved in the present application),

$${N}_{RE}^{RS}$$

denotes the reference signal overhead based on configuration or indication (not involved in the present application), and N denotes the number of target symbols calculated in the preceding embodiment.

In the embodiments of the present application, after the amount of transmitted information is determined, the information block is transmitted with the same amount of transmitted information in each retransmission, ensuring that the amount of transmitted information is the same in each transmission.

In the technical solutions of the embodiments of the present application, the method includes acquiring channel resource configuration information and/or channel resource indication information; determining the number of target symbols based on the channel resource configuration information and/or the channel resource indication information; and determining the amount of transmitted information based on the number of target symbols to transmit an information block based on the amount of transmitted information. In the method for determining the amount of transmitted information provided by the embodiments of the present application, the amount of transmitted information for each transmission of an information block is determined based on the determined number of target symbols, ensuring that the amount of transmitted information is the same in each transmission, thereby improving the success rate of data transmission.

In an embodiment, FIG. 2 is a diagram illustrating the structure of an apparatus for determining the amount of transmitted information according to an embodiment of the present application. As shown in FIG. 2, the apparatus includes a channel resource information acquisition module 210, a target symbol quantity determination module 220, and a transmission information amount determination module 230.

The channel resource information acquisition module 210 is configured to acquire channel resource configuration information and/or channel resource indication information.

The target symbol quantity determination module 220 is configured to determine the number of target symbols based on the channel resource configuration information and/or the channel resource indication information.

The transmission information amount determination module 230 is configured to determine the amount of transmitted information based on the number of target symbols to transmit an information block based on the amount of transmitted information.

Optionally, the channel resource indication information includes indicating that other channel resources are not used or indicating that other channel resources are used; the channel resource configuration information includes at least one of the following: other channel resources being configured, other channel resources not being configured, the total symbol length, the number of starting symbols, the at least one starting symbol position, the number of reserved symbols, the number of first symbols corresponding to other channel resources, or an occupancy period of other channel resources; where other channel resources include feedback channel resources and/or control channel resources.

Optionally, in response to the number of starting symbols being one, the target symbol quantity determination module 220 is also configured to perform the following:

In the case where other channel resources are configured or the occupancy period of other channel resources is 1, the number of target symbols is determined based on the total symbol length, the number of reserved symbols, and the number of first symbols.

In the case where other channel resources are configured or the occupancy period of other channel resources is greater than 1, the number of target symbols is determined based on the total symbol length, the number of reserved symbols, and the number of second symbols determined according to the channel resource indication information.

In the case where other channel resources are not configured or the occupancy period of other channel resources is 0, the number of target symbols is determined based on the total symbol length and the number of reserved symbols.

Optionally, if the channel resource indication information indicates that other channel resources are not used, the determined number of second symbols is 0; if the channel resource indication information indicates that other channel resources are used, the determined number of second symbols is equal to the number of first symbols.

Optionally, in the case where the number of starting symbols is greater than 1, the channel resource configuration information also includes at least one reference symbol length, and the target symbol quantity determination module 220 is also configured to perform the following:

In the case where other channel resources are not configured or the occupancy period of other channel resources is 0, the number of target symbols is determined based on at least one reference symbol length and the number of reserved symbols.

In the case where other channel resources are configured or the occupancy period of other channel resources is 1, the number of target symbols is determined based on the total symbol length, the number of reserved symbols, and the number of first symbols.

Optionally, in the case where the number of starting symbols is greater than 1, the channel resource configuration information also includes at least one reference symbol length, and the target symbol quantity determination module 220 is also configured to perform the following:

In the case where other channel resources are configured or the occupancy period of other channel resources is greater than 1, the number of first candidate symbols is determined based on the total symbol length, the number of reserved symbols, and the number of second symbols determined according to the channel resource indication information.

The number of second candidate symbols is determined based on the at least one reference symbol length and the number of reserved symbols.

The number of target symbols is determined from the number of first candidate symbols and the number of second candidate symbols.

Optionally, the at least one reference symbol length is configured in any one of the following manners:

In the case where the channel resource configuration information is configured with at least one symbol offset value, the at least one reference symbol length is determined based on the at least one symbol offset value and the total symbol length.

In the case where the channel resource configuration information is configured with at least one symbol length value, the at least one reference symbol length is determined based on the at least one symbol length value.

Optionally, in the case where the channel resource configuration information includes at least one reference symbol length, the channel resource indication information also includes using the at least one reference symbol length or using the total symbol length; or, the transmission is a transmission for initiation of a channel occupancy time or a transmission within a channel occupancy time.

Optionally, the target symbol quantity determination module 220 is also configured to perform the following:

In the case where the at least one reference symbol length includes one reference symbol length and the resource indication information indicates that the one reference symbol length is used or that the transmission is a transmission for initiation of a channel occupancy time, the number of target symbols is determined based on the one reference symbol length and the number of reserved symbols.

In the case where the resource indication information indicates using the total symbol length or that the transmission is a transmission within a channel occupancy time, the number of target symbols is determined based on the total symbol length, the number of reserved symbols, and the number of first symbols, or the number of target symbols is determined based on the total symbol length, the number of reserved symbols, and the number of second symbols determined according to the channel resource indication information.

Optionally, in the case where the at least one reference symbol length includes multiple reference symbol lengths, the resource indication information also includes an indication field for determining the used reference symbol length; the target symbol quantity determination module 220 is also configured to determine the used reference symbol length based on the indication field; and determine the number of target symbols based on the used reference symbol length.

Optionally, the target symbol quantity determination module 220 is also configured to perform the following:
In the case where the indication field indicates that the transmission is a transmission for initiation of a channel occupancy time, the used reference symbol length is determined based on the reference symbol length corresponding to the initiation of the channel occupancy time; and, in the case where the indication field indicates that the transmission is a transmission within a channel occupancy time, the used reference symbol length is determined based on the reference symbol length corresponding to the transmission within the channel occupancy time.

Alternatively, the used reference symbol length is determined based on a symbol length value or a symbol length index value indicated by the indication field.

Optionally, in the case where other channel resources are configured or the occupancy period of other channel resources is greater than 1, the target symbol quantity determination module 220 is also configured to perform the following:

The number of third candidate symbols is determined based on the total symbol length, the number of reserved symbols, and the number of second symbols determined according to the channel resource indication information.

The number of fourth candidate symbols is determined based on the used reference symbol length and the number of reserved symbols.

The number of target symbols is determined from the number of third candidate symbols and the number of fourth candidate symbols.

In an embodiment, FIG. 3 is a diagram illustrating the structure of a computer device according to an embodiment of the present application. As shown in FIG. 3, the device provided in the present application includes a processor 310 and a memory 320. One or more processors 310 may be included in the device. One processor 310 is shown as an example in FIG. 3. One or more memories 320 may be included in the device. One memory 320 is shown as an example in FIG. 3. The processor 310 and the memory 320 in the device may be connected by a bus or in other manners. FIG. 3 shows a connection by the bus as an example. In this embodiment, the device is a computer device.

The memory 320, as a computer-readable storage medium, may be configured to store software programs, computer executable programs, and modules such as program instructions/modules (such as a coding module and a first sending module in the data transmission apparatus) corresponding to the device in any embodiment of the present application. The memory 320 may include a program storage region and a data storage region. The program storage region may store an operating system and an application program required by at least one function. The data storage region may store data created depending on the use of the device. Moreover, the memory 320 may include a high-speed random-access memory and may also include a non-volatile memory such as at least one magnetic disk memory, a flash memory, or another non-volatile solid-state memory. In some examples, the memory 320 may also include memories that are remotely disposed relative to the processor 310, and these remote memories may be connected to the device via a network. Examples of the preceding network include but are not limited to, the Internet, an intranet, a local area network, a mobile communication network, and a combination thereof.

The device provided above may be configured to execute the method for determining the amount of transmitted information provided by any of the preceding embodiments and has corresponding functions and effects.

The program stored in the memory 320 may be program instructions/modules corresponding to the method for determining the amount of transmitted information provided by the embodiments of the present application. The processor 310, by executing software programs, instructions, and modules stored in the memory 320, performs one or more functional applications and data processing of the computer device, thereby implementing the association query method applied to data in the preceding method embodiments. It is to be understood that when the device is a receiving end, it can execute the method for determining the amount of transmitted information provided by any embodiment of the present application and has corresponding functions and effects.

Embodiments of the present application also provide a storage medium containing computer-executable instructions, which, when executed by a computer processor, are configured to perform a method for determining the amount of transmitted information. The method includes acquiring channel resource configuration information and/or channel resource indication information; determining the number of target symbols based on the channel resource configuration information and/or the channel resource indication information; determining the amount of transmitted information based on the number of target symbols to transmit an information block according to the amount of transmitted information.

It is to be understood by those skilled in the art that the term “user equipment” covers any suitable type of wireless user equipment, for example, a mobile phone, a portable data processing apparatus, a portable web browser, or a vehicle-mounted mobile station.

Generally speaking, various embodiments of the present application may be implemented in hardware or special-purpose circuits, software, logic, or any combination thereof. For example, some aspects may be implemented in hardware while other aspects may be implemented in firmware or software executable by a controller, a microprocessor, or another computing apparatus, though the present application is not limited thereto.

Embodiments of the present application may be implemented through the execution of computer program instructions by a data processor of a mobile apparatus, for example, implemented in a processor entity, by hardware, or by a combination of software and hardware. The computer program instructions may be assembly instructions, instruction set architecture (ISA) instructions, machine instructions, machine-related instructions, microcodes, firmware instructions, state setting data, or source or object codes written in any combination of one or more programming languages.

A block diagram of any logic flow among the drawings of the present application may represent program procedures, may represent interconnected logic circuits, modules, and functions, or may represent a combination of program procedures with logic circuits, modules, and functions. Computer programs may be stored in a memory. The memory may be of any type suitable for a local technical environment and may be implemented using any suitable data storage technology such as, but not limited to, a read-only memory (ROM), a random-access memory (RAM), or an optical memory device and system (a digital video disc (DVD), or a compact disc (CD)). The computer-readable medium may include a non-transitory storage medium. The data processor may be of any type suitable for the local technical environment, such as, but not limited to, a general-purpose computer, a special-purpose computer, a microprocessor, a digital signal processor (DSP), an application-specific integrated circuit (ASIC), a field-programmable gate array (FPGA), and a processor based on a multi-core processor architecture.

The preceding descriptions are only example embodiments of the present application and are not intended to limit the scope of the present application.

Embodiments of the present application may be implemented through the execution of computer program instructions by a data processor of a mobile apparatus, for example, implemented in a processor entity, by hardware, or by a combination of software and hardware. The computer program instructions may be assembly instructions, instruction set architecture (ISA) instructions, machine instructions, machine-related instructions, microcodes, firmware instructions, state setting data, or source codes or object codes written in any combination of one or more programming languages.

What is claimed is:

1. A method for determining an amount of transmitted information, comprising:
acquiring at least one of channel resource configuration information or channel resource indication information;
determining a number of target symbols based on at least one of the channel resource configuration information or the channel resource indication information; and
determining the amount of transmitted information based on the number of target symbols to transmit an information block based on the amount of transmitted information.

2. The method according to claim 1, wherein the channel resource indication information comprises indicating that other channel resources are not used or indicating that other channel resources are used; the channel resource configuration information comprises at least one of the following: other channel resources being configured, other channel resources not being configured, a total symbol length, a number of starting symbols, at least one starting symbol position, a number of reserved symbols, a number of first symbols corresponding to other channel resources, or an occupancy period of other channel resources; wherein the other channel resources comprise at least one of feedback channel resources or control channel resources.

3. The method according to claim 2, wherein in response to the number of starting symbols being one, determining the number of target symbols based on at least one of the channel resource configuration information or the channel resource indication information comprises:
in response to other channel resources being configured or the occupancy period of other channel resources being 1, determining the number of target symbols based on the total symbol length, the number of reserved symbols, and the at least one starting symbol position;
in response to other channel resources being configured or the occupancy period of other channel resources being greater than 1, determining the number of target symbols based on the total symbol length, the number of reserved symbols, and a number of second symbols determined according to the channel resource indication information; and
in response to other channel resources not being configured or the occupancy period of other channel resources being 0, determining the number of target symbols based on the total symbol length and the number of reserved symbols.

4. The method according to claim 3, wherein in response to the channel resource indication information indicating that other channel resources are not used, the number of second symbols is determined to be 0; and in response to the channel resource indication information indicating that other channel resources are used, the number of second symbols is determined to be equal to the number of first symbols.

5. The method according to claim 2, wherein in response to the number of starting symbols being greater than 1, the channel resource configuration information further comprises at least one reference symbol length, and determining the number of target symbols based on at least one of the channel resource configuration information and the channel resource indication information comprises:
in response to other channel resources not being configured or the occupancy period of other channel resources being 0, determining the number of target symbols based on the at least one reference symbol length and the number of reserved symbols; and
in response to other channel resources being configured or the occupancy period of other channel resources being 1, determining the number of target symbols based on the total symbol length, the number of reserved symbols, and the number of first symbols.

6. The method according to claim 2, wherein in response to the number of starting symbols being greater than 1, the channel resource configuration information further comprises a at least one reference symbol length, and determining the number of target symbols based on at least one of the channel resource configuration information and the channel resource indication information comprises:
in response to other channel resources not being configured, determining the number of target symbols based on the at least one reference symbol length and the number of reserved symbols; and
in response to other channel resources being configured, determining the number of target symbols based on the at least one reference symbol length, the number of reserved symbols, and a number of second symbols determined according to the channel resource indication information.

7. The method according to claim 2, wherein in response to the number of starting symbols being greater than 1, the channel resource configuration information further comprises at least one reference symbol length, and determining the number of target symbols based on at least one of the channel resource configuration information and the channel resource indication information comprises:
in response to other channel resources being configured or the occupancy period of other channel resources being greater than 1, determining a number of first candidate symbols based on the total symbol length, the number of reserved symbols, and a number of second symbols determined according to the channel resource indication information;
determining a number of second candidate symbols based on the at least one reference symbol length and the number of reserved symbols; and
determining the number of target symbols from the number of first candidate symbols and the number of second candidate symbols.

8. The method according to claim 7, wherein the at least one reference symbol length is configured in any one of the following manners:
in response to the channel resource configuration information being configured with at least one symbol offset value, the at least one reference symbol length is determined based on the at least one symbol offset value and the total symbol length; or
in response to the channel resource configuration information being configured with at least one symbol length value, the at least one reference symbol length is determined based on the at least one symbol length value.

9. The method according to claim 2, wherein in response to the channel resource configuration information comprising a at least one reference symbol length, the channel resource indication information further comprises indicating that: the number of the at least one reference symbol or the total symbol length is used; or, a transmission is a transmission for initiation of a channel occupancy time or a transmission within a channel occupancy time.

10. The method according to claim 9, wherein determining the number of target symbols based on at least one of the channel resource configuration information or the channel resource indication information comprises:
in response to the at least one reference symbol length being one and the resource indication information indicating that the at least one reference symbol length is used or that the transmission is transmission for the initiation of the channel occupancy time, determining the number of target symbols based on the at least one reference symbol length and the number of reserved symbols; and
in response to the resource indication information indicating that the total symbol length is used or the transmission being the transmission within the channel occupancy time, determining the number of target symbols based on the total symbol length, the number of reserved symbols, and the number of first symbols, or determining the number of target symbols based on the total symbol length, the number of reserved symbols, and a number of second symbols determined according to the channel resource indication information.

11. The method according to claim 9, wherein in response to the at least one reference symbol length comprising a plurality of reference symbol lengths, the resource indication information further comprises an indication field for determining a used reference symbol length, and determining the number of target symbols based on at least one of the channel resource configuration information or the channel resource indication information comprises:
determining the used reference symbol length based on the indication field; and
determining the number of target symbols based on the used reference symbol length.

12. The method according to claim 11, wherein determining the used reference symbol length based on the indication field comprises:
in response to the indication field indicating that the transmission is the transmission for the initiation of the channel occupancy time, determining the used reference symbol length based on a reference symbol length corresponding to the initiation of the channel occupancy time; and, in response to the indication field indicating that the transmission is the transmission within the channel occupancy time, determining the used reference symbol length based on a reference symbol length corresponding to the transmission within the channel occupancy time; or
determining the used reference symbol length based on a symbol length value or a symbol length index value indicated by the indication field.

13. The method according to claim 11, wherein in response to other channel resources being configured or the occupancy period of other channel resources being greater than 1, determining the number of target symbols based on the used reference symbol length comprises:
determining a number of third candidate symbols based on the total symbol length, the number of reserved symbols, and a number of second symbols determined according to the channel resource indication information;
determining a number of fourth candidate symbols based on the used reference symbol length and the number of reserved symbols; and
determining the number of target symbols from the number of third candidate symbols and the number of fourth candidate symbols.

14. An apparatus for determining an amount of transmitted information, comprising:
a channel resource information acquisition module configured to acquire at least one of channel resource configuration information or channel resource indication information;
a target symbol quantity determination module configured to determine a number of target symbols based on at least one of the channel resource configuration information or the channel resource indication information; and
a transmission information amount determination module configured to determine the amount of transmitted information based on the number of target symbols to transmit an information block based on the amount of transmitted information.

15. A computer device, comprising a memory, a processor, and a computer program stored in the memory and executable by the processor, wherein the processor, when executing the computer program, implements the method for determining an amount of transmitted information of any one of claims 1 to 13.

16. A computer-readable storage medium storing a computer program that, when performed by a processor, implements the method for determining an amount of transmitted information according to any one of claims 1 to 13.
